(19) United States
(12) Patent Application Publication
(10) Pub. No.: US 2018/0147766 A1
(43) Pub. Date: May 31, 2018

(54) ROTOCHROMIC ARRAYS AND METHODS OF MAKING AND USING THE SAME

(71) Applicant: 3M INNOVATIVE PROPERTIES COMPANY, St. Paul, MN (US)

(72) Inventors: Ravi K. Sura, Bangalore (IN); Thomas P. Hanschen, Mendota Heights, MN (US); Ronald W. Ausen, Saint Paul, MN (US); Bridget K. Warmka, Oakdale, MN (US)

(21) Appl. No.: 15/576,216

(22) PCT Filed: May 27, 2016
(86) PCT No.: PCT/US2016/034559

§ 371 Date: Nov. 21, 2017

Related U.S. Application Data
(60) Provisional application No. 62/167,155, filed on May 27, 2015.

(51) Int. Cl. B29C 47/00; B29C 47/06; B32B 27/06; B32B 7/12; B32B 27/32; B32B 37/14; G02B 1/04

(52) U.S. Cl. CPC B29C 47/0021; B29C 47/003; B29C 47/06; B32B 27/06; B29L 2011/00; B32B 27/32; B32B 37/14; G02B 1/04; B32B 7/12

(57) ABSTRACT

Method for using sheets comprising co-extruded multi-component arrays that exhibit chromatically variable appearance dependent upon observation angle.

### FIELD

The present invention relates to sheets comprising co-extruded multi-component arrays, in particular, sheets exhibiting chromatically variable appearance dependent upon observation orientation, and methods for making and using such sheets.

### BACKGROUND

Co-extrusion of multiple polymeric components into a single film is known in the art. For example, it is known to provide co-extruded film structures where the film is partitioned, not as coextensive layers in the thickness direction, but as stripes or strands along the width dimension of the film. This has sometimes been called “side-by-side” co-extrusion. Extruded products with side-by-side oriented stripes are described, for example, in U.S. Pat. No. 4,435,141 (Weisner, et al.) and U.S. Pat. No. 6,159,544 (Liu, et al.), US Pat. App. Pub. No. 2014/0093716 and International Pat. App. Pub. No. WO 2011/119323 (Ausen, et al.).

### SUMMARY

The present invention provides novel sheets comprising co-extruded composite arrays of polymeric ribbons and strands that provide surprising performance and novel methods of making and using such arrays to achieve surprising benefits and advantages. Arrays of the invention can provide several surprising performance advantages, including rotochromic appearance (i.e., the color of the array can vary dependent upon the orientation from which it is observed).

In brief summary, a sheet of the invention has front and back major surfaces and comprises a first array of a plurality of polymeric ribbons and a plurality of polymeric strands, the plurality of polymeric ribbons comprising first polymeric ribbons and the plurality of polymeric strands comprising first polymeric strands, wherein:
(1) each of the polymeric ribbons and polymeric strands is of elongate form (i.e., having more length than width or thickness) having a longitudinal axis, has two opposing sides, two opposing ends, and two opposing edges, and has a width, length, and thickness;
(2) each of the polymeric ribbons has a thickness-to-width aspect ratio of at least three-to-one, at least one side that is substantially continuously bonded to a polymeric strand, and a thickness greater than the thickness of the polymeric strands;
(3) the longitudinal axes of the polymeric ribbons and polymeric strands are substantially parallel, the polymeric ribbons and polymeric strands are arranged in the array such that the first edges of the first polymeric ribbons are oriented in common direction from the polymeric strands so as to define the front major surface of the sheet; and
(4) the polymeric ribbons and polymeric strands have a perceptibly different optical appearance, such that when the first array exhibits a first optical appearance at a first orientation and a second optical appearance at a second orientation, the first optical appearance being perceptibly distinct from the second optical appearance.

We have discovered that such arrays can be configured to achieve differentiated optical appearance (e.g., such as variable color, sparkle, or other optical effect), depending upon the orientation perspective. In other words, the color of the array will appear different, perhaps strikingly so, depending upon the angle from which it is observed.

Briefly summarizing, illustrative methods of the invention include methods of making such sheets via coextrusion of ribbons and strands in arrays as described herein as well as methods of using sheets as described herein.

### BRIEF DESCRIPTION OF THE DRAWINGS

The disclosure may be more completely understood in consideration of the following detailed description of various embodiments of the disclosure in connection with the accompanying drawings, in which:

FIG. 1 is a perspective view of a portion of an illustrative array of the invention;

FIG. 2 is a cross-sectional view of a portion of an illustrative array of the invention;

FIG. 3A is schematic diagram of observation perspective of the front surface of an array of the invention;

FIG. 3B is a photomicrograph of a portion of an illustrative array of the invention;

FIGS. 4A-4D are each a cross-sectional view of a portion of an illustrative array of the invention;

FIGS. 5A-5B are photomicrographs of cross-sections of portions of the array made in Example 1;

FIG. 6 is a photomicrograph of a cross-section of a portion of the array made in FIG. 2;

FIG. 7 is a photomicrograph of a cross-section of a portion of the array made in FIG. 3;

FIG. 8 is a photomicrograph of a cross-section of a portion of the array made in FIG. 4;

FIG. 9 is a photomicrograph of a cross-section of a portion of the array made in FIG. 5; and

FIG. 10 is a photomicrograph of a cross-section of a portion of the array made in FIG. 10.

The line drawings are idealized and not to scale. The figures are intended to be merely illustrative and not limiting.

### Glossary

For the following defined terms, these definitions shall be applied, unless a different definition is given in the claims or elsewhere in this specification.

In this application, terms such as “a”, “an” and “the” are not intended to refer to only a singular entity, but include the general class of which a specific example may be used for illustration. The terms “a”, “an”, and “the” are used interchangeably with the term “at least one”. The phrases “at least one of” and “comprises at least one of” followed by a list refers to any one of the items in the list and any combination of two or more items in the list. All numerical ranges are inclusive of their endpoints and non-integral values between the endpoints unless otherwise stated (e.g., 1 to 5 includes 1, 1.5, 2, 2.75, 3, 3.80, 4, and 5).

The term “polymer” will be understood to include polymers, copolymers (e.g., polymers formed using two or more different monomers), oligomers and combinations thereof, as well as polymers, oligomers, or copolymers. Both block and random copolymers are included, unless indicated otherwise.

Unless otherwise indicated, all numbers expressing quantities of ingredients, properties such as molecular weight, reaction conditions, and so forth used in the specification and claims are to be understood as being modified in all instances by the term “about”. Accordingly, unless indicated to the contrary, the numerical parameters set forth in the foregoing specification and attached claims are approximations that can vary depending upon the desired properties sought to be obtained by those skilled in the art utilizing the teachings of the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviations found in their respective testing measurements.

A major surface of the polymeric ribbons is a surface defined by the height and the length of the ribbon.

The terms “multiple” and “a plurality” refer to more than one.

The term “elastic” refers to any material (such as a film that is 0.002 mm to 0.5 mm thick) that exhibits recovery from stretching or deformation. In some embodiments, a material may be considered to be elastic if, upon application of a stretching force, it can be stretched to a length that is at least about 25 (in some embodiments, 50) percent greater than its initial length and can recover at least 40 percent of its elongation upon release of the stretching force.

“Elongation” in terms of percent refers to {(the extended length−the initial length)/the initial length} multiplied by 100.

The above summary of the present disclosure is not intended to describe each disclosed embodiment or every implementation of the present disclosure. The description that follows more particularly exemplifies illustrative embodiments. It is to be understood, therefore, that the following description should not be read in a manner that would unduly limit the scope of this disclosure.

### DETAILED DESCRIPTION OF ILLUSTRATIVE EMBODIMENTS

Sheets

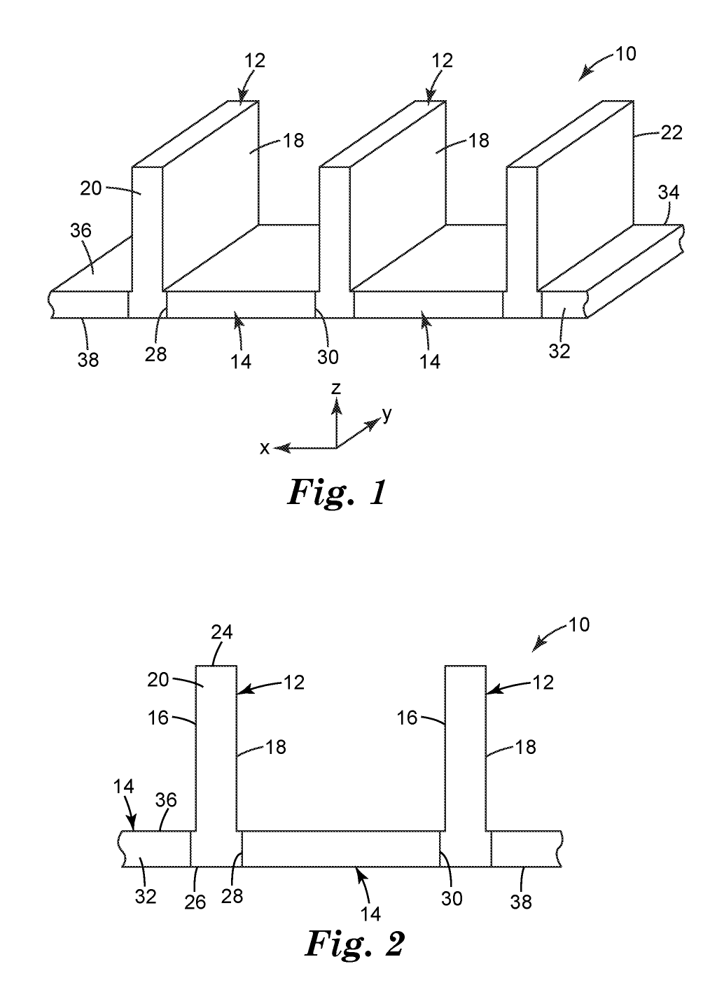

FIG. 1 illustrates a perspective view of a portion of an illustrative embodiment of a sheet 10 of the present invention and FIG. 2 illustrates an end view of a portion of an illustrative embodiment of as sheet 10 of the invention. The sheet 10 comprises an array of a plurality of polymeric ribbons 12 and plurality of polymeric strands 14.

Each polymeric ribbon 12 has first side 16, and opposing second side 18, first end 20, and opposing second end 22 (obscured in FIGS. 1 and 2), and first face 24, and second opposing face 26.

Each polymeric strand 14 has first side 28, and opposing second side 30, first end 32, and opposing second end 34 (obscured in FIGS. 1 and 2), and first face 36, and second opposing face 38.

The polymeric ribbons and polymeric strands each have a width, length, and thickness and are elongate in form (i.e., the length is greater than the width and thickness).

The ribbons and strands are arranged in substantially parallel position in the array, typically with each ribbon being bounded on opposing sides by two strands, and each strand being bounded on opposing sides by two ribbons.

Sheets of the invention have substantially sheet-like configuration (i.e., they are typically somewhat larger in two dimensions than in thickness).

For ease of discussion, this description will refer to orientation of components of arrays of the invention in an x-y-z set of axes as shown in FIG. 1. In this perspective, the ribbons and strands, which are elongate, each has a longitudinal axis or length in the y direction, each has a width in the x direction, and each has a thickness in the z direction.

In some embodiments, the individual ribbons and strands are flexible as is the resultant array.

In many embodiments, the ribbons and strands are selected such that the resultant array is flexible in at least one, sometimes two, and in some instances, all three of the x-y-z axes.

The ribbons and strands each have a generally rectangular or oblong cross-section (i.e., in the x-z plane).

In many embodiments, each of the ribbons has a thickness-to-width aspect ratio of at least three-to-one. The thickness of the ribbons is greater than the thickness of the strands.

Each ribbon is continuously bonded on at least one side (in the case of the outermost ribbons) and typically on at least two sides (in the case of other ribbons), with a projection extending beyond the plane defined by the strands. The projections may extend substantially perpendicularly from the plane defined by the strands, or the projections may be angled

At least a portion of each ribbon as different optical appearance (e.g., color) than that of portions of the strands adjacent thereto.

Arrays of the invention provide orientation dependent chromatic variability (i.e., they appear to be of different color when observed from certain perspectives. Typically the most impactful variability is seen by observing the array from a perspective that is substantially perpendicular to or within a defined angular offset 0 (e.g., within 45° of an x-z plane through the reference point). At a perspective that is substantially perpendicular to the x-y plane through the reference point, the chromatic contribution of the strands will achieve its relative maximum, and at progressively greater angular offsets, up to the limit of an oblique or essentially 90° offset, the chromatic contribution of the ribbons will be relatively more dominant.

Depending upon the embodiment, each ribbon may be of substantially uniform optical appearance. In some embodiments, portions of a ribbon may have differentiated optical appearance; in such instances typically a number of neighboring ribbons will share a coherent arrangement of differentiated optical appearance.

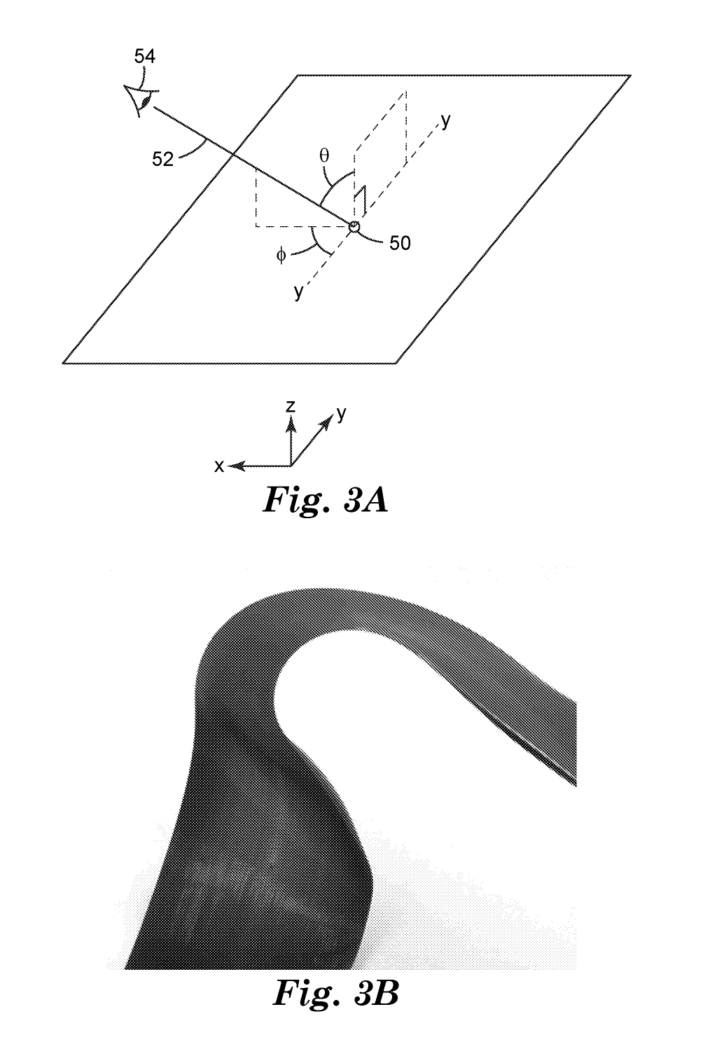

Reference is made to FIG. 3A, which shows an illustration of a sheet 10 of the invention in substantially planar configuration. As each portion of the front surface of an array of the invention is observed, the observation perspective or orientation of each point 50 (ray 52 from observer 54) can be described by the two angles Θ and Φ wherein Θ, which may be from 0° to nearly 90°, is the declination from y-z plane through the observed point (i.e., Θ is 0° when looking straight down on the array in an orientation parallel to the z-axis) and Φ, which may be from 0° to 90°, is the angle of the projection 56 of the observation vector 52 on the x-y plane (i.e., Φ is 0° when looking at the array in a perspective parallel to the y-axis).

Each point of the front surface which is within in the field of view will be a unique Θ and Φ of observation, particularly if the sheet being observed is of large dimension or in other than substantially flat or planar configuration. For instance, FIG. 3B shows the variation in observed optical appearance of a strip-shaped length of a sheet of the invention arranged in complex configuration. In this embodiment, the sheet comprises red ribbons and green strands. At areas of low Θ, the apparent color of the array is dominated by the green of the strands whereas at areas of relatively higher Θ, the apparent color of the array is dominated by the red of the ribbons.

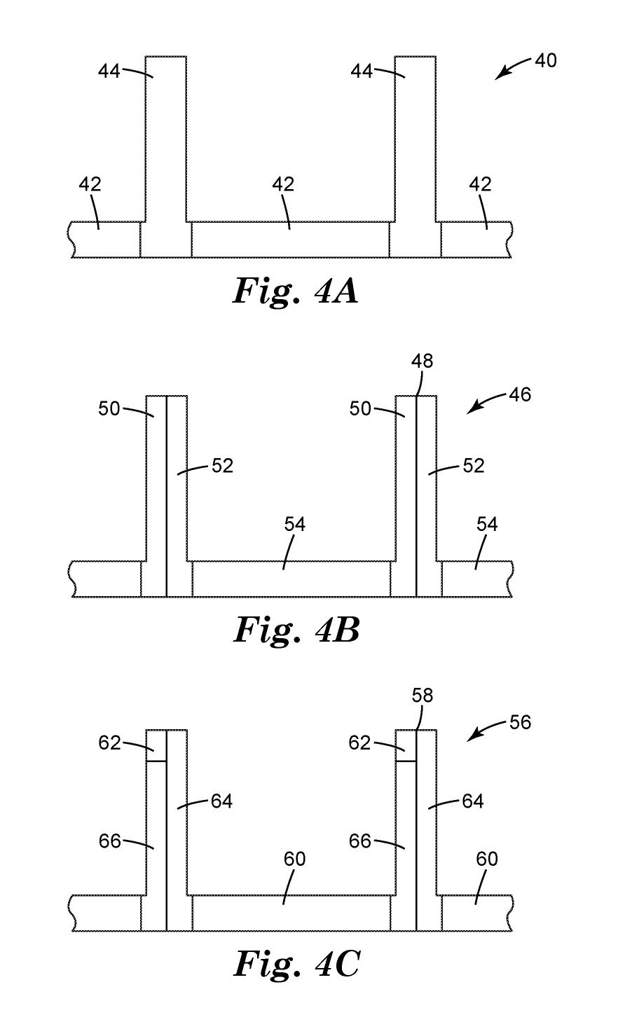

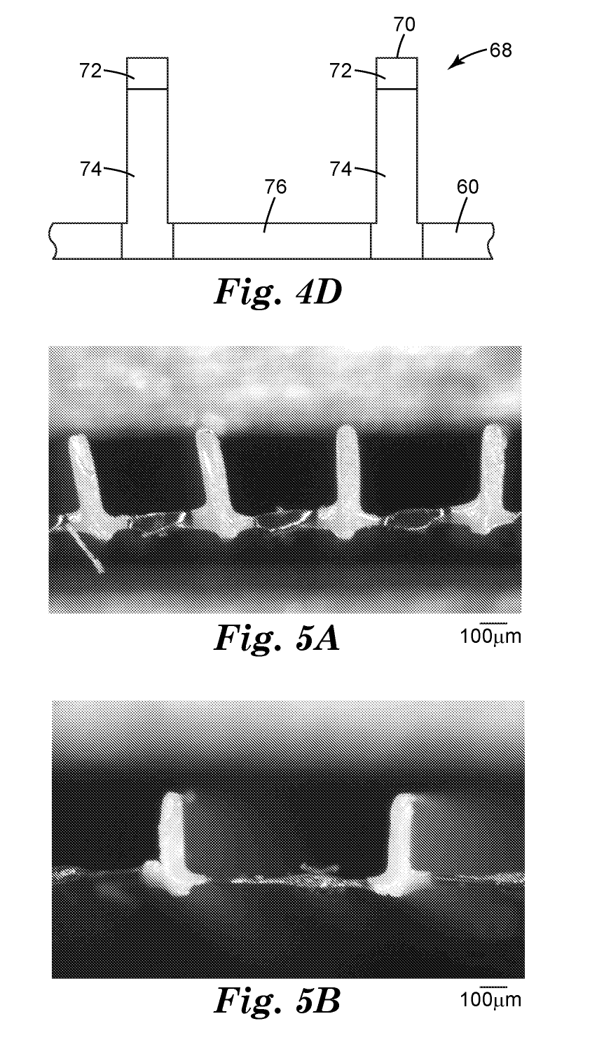

If desired, the polymeric ribbons, the polymeric strands, or both may comprise one or more longitudinally oriented segments having different optical appearance. FIGS. 4A-4D show illustrative embodiments. In the embodiment shown in FIG. 4A, in array 40 each ribbon 44 and strand 42 comprises a single segment. When observed at a highly oblique perspective (e.g., Θ is 45° or more), the observed appearance will be largely defined by the color of the ribbons, and as the perspective is shifted (i.e., reducing Θ), as the first surface of the strands comes into view, relative contribution of the color of the ribbons will be lessened and relative contribution of the strands will increase, reaching its maximum at vertical orientation (i.e., Θ is low or even 0°), and then reversing.

In the embodiment shown in FIG. 4B, the relative contribution of color by the ribbons 48 of array 46 will be minimized and that of the strands 54 maximized at a relatively vertical orientation (i.e., Θ is low). At a relatively oblique perspective from the left (as drawn), the contribution of color of segments 50 will be dominant, whereas at a relatively oblique perspective from the right (as drawn), the contribution of color of segments 52 will be dominant. The materials used to form segments 50 and 52, as well as of the strands 54 may be selected as desired to achieve a wide variety of variable color effects. Example 6 is an illustrative example of the embodiment shown in FIG. 4B, see also FIG. 10.

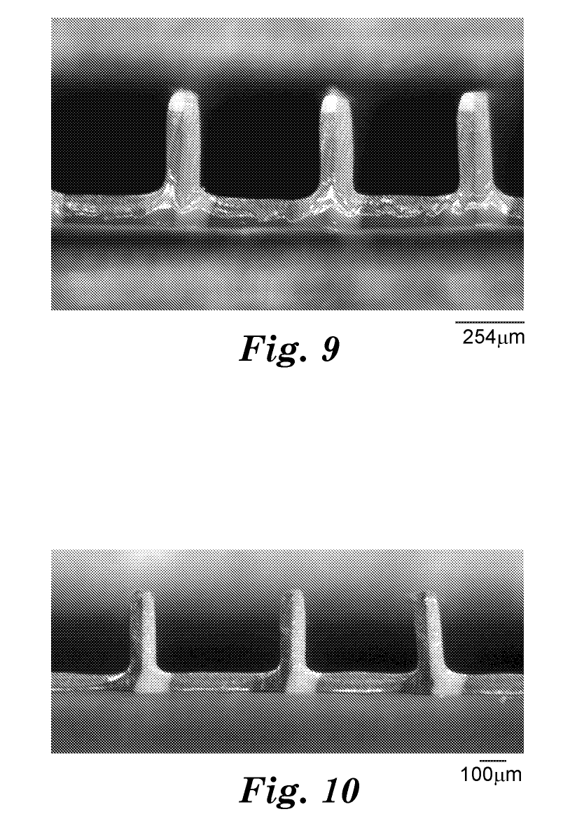

In the embodiment shown in FIG. 4C, the relative contribution of color by the ribbons 58 of array 56 will be minimized and that of the strands 60 maximized at vertical orientation. At a relatively oblique perspective (i.e., Θ is relatively high) from the left (as drawn), the contribution of color of segments 62 will be dominant, whereas at a relatively oblique perspective from the right (as drawn), the contribution of color of segments 64 will be dominant. As the perspective shifts from relatively oblique from the left (as drawn) toward less oblique (i.e., Θ becomes lower), the contribution of color of segments 66 will arise. As will be understood, the chromatic response or appearance of arrays of the invention can be configured as desired by changing the relative dimensions of the ribbons and segments, and their constituent segments, if any. Example 5 is an illustrative example of the embodiment shown in FIG. 4C, see also FIG. 9.

Another embodiment is shown in FIG. 4D wherein array 68 comprises ribbons 70 each comprising upper segments 72 and lower segments 74 and strands 76. where the contribution of color by the ribbons is symmetrical from the left or right sides (as drawn), with a shift in appearance between perspectives where Θ is relatively low where ribbon upper segments 72 and strands 76 predominate, shifting at relatively more oblique perspectives with higher Θ as the visibility of strands 76 is reduced and ultimately occluded with ribbon lower segments 74 attaining higher prominence.

Those skilled in the art will be able to readily select desired combinations of colors and dimensions of ribbons, strands, and optionally segments thereof, as desired to achieve desired ranges of perspective dependent chromaticity (desired optical appearance at select ranges of observation perspectives or angles Θ and Φ).

Method of Making

Although other methods may be useful, the arrays disclosed herein in any of their embodiments can conveniently be prepared by an extrusion die and/or method according to the present disclosure. The extrusion die according to the present disclosure has a variety of passageways from cavities within the die to dispensing orifices. The dispensing orifices each have a width, which is the dimension that corresponds to the width of a particular polymeric ribbon or polymeric strand, and a height, which is the dimension that corresponds to the thickness of the resulting extruded array and the height of a particular polymeric ribbon or polymeric strand. The height of a dispensing orifice can also be considered the distance between the top edge and the bottom edge of the dispensing orifice.

In the extrusion die and method of making an array of the present invention, the extrusion die has at least one cavity, a dispensing surface, and fluid passageways between the at least one cavity and the dispensing surface. The dispensing surface has an array of first and third dispensing orifices interspersed with an array of discrete, substantially vertically aligned second dispensing orifices. This means that for any two first and/or third dispensing orifices, there is at least one second dispensing orifice between them. However, it is possible that for any two first and/or third dispensing orifices, there is more than one second dispensing orifice between them, and there may be dispensing orifices other than the second dispensing orifices between them. The array of first dispensing orifices is vertically and horizontally offset from the array of third dispensing orifices.

The fluid passageways are capable of physically separating the polymers from the at least one cavity (e.g., first and second cavities and optionally any further die cavities within the extrusion die) until the fluid passageways enter the dispensing orifices. The shape of the different passageways within the die may be identical or different. Examples of passageway cross-sectional shapes include round, square, and rectangular shapes. These cross-sectional shapes, selection of polymeric material, and die swell can influence the cross-sectional shape of the ribbons and strands.

In many embodiments, the extrusion die includes at least a first and second cavity, with first fluid passageways between the first cavity and the first dispensing orifices and second fluid passageways between the second cavity and the second dispensing orifices. The extrusion die may also have third fluid passageways between the first cavity or a third cavity and the third dispensing orifices. In the illustrated embodiment, the extrusion die has a third cavity, and the third fluid passageways are between the third cavity and the third dispensing orifices. At least one of the first dispensing orifices or third dispensing orifices have a height-to-width aspect ratio of at least 3:1 (in some embodiments, at least 5:1, 8:1, 10:1, 11:1, 15:1, 20:1, 30:1, or 40:1), and the height of at least one of the first and third dispensing orifices is typically larger than the height of the second dispensing orifices. In some embodiments, the height of at least one of the first dispensing orifices or third dispensing orifices is larger (in some embodiments, at least 2, 2.5, 3, 5, 10, or 20 times larger) than the height of the second dispensing orifices. In some embodiments, the first dispensing orifices, second dispensing orifices, third dispensing orifices, and any other dispensing orifices are arranged one-by-one across the dispensing surface. That is, in these embodiments, in the width dimension of the die, the dispensing orifices are arranged singly or one-by-one regardless of the alignment of the dispensing orifices in these embodiments. For example, the dispensing orifices are not stacked in a group of two, three, or more in the height direction, and one first or third dispensing orifice is disposed between any two adjacent second dispensing orifices. Furthermore, in some embodiments, one first dispensing orifice is disposed between any two adjacent third dispensing orifices, and one third dispensing orifice is disposed between any two adjacent first dispensing orifices. In other embodiments, there may be more than one second dispensing orifices (e.g., two) stacked in the height direction and interspersed between the first and third dispensing orifices.

The size of the polymeric ribbons and polymeric strands can be adjusted, for example, by the composition of the extruded polymers, velocity of the extruded strands, and/or the orifice design (e.g., cross-sectional area (e.g., height and/or width of the orifices)). As taught in International Pat. App. Pub. No. WO 2013/028654 (Ausen et al.), a dispensing surface with a first polymer orifice three times greater in area than the second polymer orifice may not generate an array with polymeric ribbons with a height greater than the polymeric strands depending on the identity of the polymeric compositions and the pressure within the cavities. In some embodiments of the extrusion die and method according to the present disclosure, the height-to-width aspect ratio of the orifices is at least 5:1.

Conveniently, the extrusion die according to and/or useful for practicing the present disclosure may be comprised of a plurality of shims. The plurality of shims together define the at least one cavity, the dispensing surface, and the fluid passageways between the at least one cavity and the dispensing surface. In some embodiments, the plurality of shims comprises a plurality of sequences of shims wherein each sequence comprises at least one first shim that provides a first fluid passageway between the at least one cavity and at least one of the first dispensing orifices, at least one second shim that provides a second fluid passageway between the at least one cavity and at least one of the second dispensing orifices, and at least one third shim that provides a third fluid passageway between the at least one cavity and at least one of the third dispensing orifices. In some embodiments, the shims together define a first cavity and a second cavity, the extrusion die having a plurality of first dispensing orifices in fluid communication with the first cavity, a plurality of second dispensing orifices in fluid communication with the second cavity, and a plurality of third dispensing orifices in fluid communication with the first cavity or a third cavity (in some embodiments, the third cavity).

In some embodiments, the shims will be assembled according to a plan that provides a sequence of shims of diverse types. Since different applications may have different requirements, the sequences can have diverse numbers of shims. The sequence may be a repeating sequence that is not limited to a particular number of repeats in a particular zone. Or the sequence may not regularly repeat, but different sequences of shims may be used.

The polymeric compositions useful in the ribbons and strands of arrays of the invention may be the substantially the same or different, so long as the resultant members exhibit the desired differentiated optical appearance. In some embodiments, the polymeric ribbons and polymeric strands comprise different polymeric compositions. These arrays can be prepared, for example, by extrusion using any embodiments of the method described above by using different polymeric compositions in the first, second, and optionally third cavities. The different polymeric compositions in the polymeric ribbons and polymeric strands may be selected for their surface properties or their bulk properties (e.g., tensile strength, elasticity, microstructure, color, refractive index, etc.). Furthermore, polymeric compositions can be selected to provide specific functional or aesthetic properties in the polymeric array such as hydrophilicity/hydrophobicity, elasticity, softness, hardness, stiffness, bendability, or colors. The term “different” in terms of polymeric compositions can also refer to at least one of (a) a difference of at least 2% in at least one infrared peak, (b) a difference of at least 2% in at least one nuclear magnetic resonance peak, (c) a difference of at least 2% in the number average molecular weight, or (d) a difference of at least 5% in polydispersity.

In any embodiments of the method disclosed herein, polymers used to make the polymeric ribbons and polymeric strands are selected to be compatible with each other such that the polymeric ribbons and polymeric strands bond together. Bonding generally refers to melt-bonding, and the bonds between polymer strands and polymeric ribbons can be considered to be melt-bonded. The bonding occurs in a relatively short period of time (typically less than about 1 second). The bond regions on the major surface of the polymeric ribbons, as well as the polymeric strands, typically cool through air and natural convection and/or radiation. In selecting polymers for the polymeric ribbons and polymeric strands, in some embodiments, it may be desirable to select polymers of bonding strands that have dipole interactions (or H-bonds) or covalent bonds. Bonding between polymer ribbons and strands has been observed to be improved by increasing the time that the polymeric ribbons and polymeric strands are molten to enable more interaction between polymers. Bonding of polymers has generally been observed to be improved by reducing the molecular weight of at least one polymer and or introducing an additional co-monomer to improve polymer interaction and/or reduce the rate or amount of crystallization.

Examples of polymeric materials from which arrays of the invention can be made include thermoplastic polymers. Suitable thermoplastic polymers for the polymeric arrays include polyolefin homopolymers such as polyethylene and polypropylene, copolymers of ethylene, propylene and/or butylene; copolymers containing ethylene such as ethylene vinyl acetate and ethylene acrylic acid; ionomers based on sodium or zinc salts of ethylene methacrylic acid or ethylene acrylic acid; polyvinyl chloride; polyvinylidene chloride; polystyrenes and polystyrene copolymers (styrene-maleic anhydride copolymers, styrene acrylonitrile copolymers); nylons; polyesters such as poly(ethylene terephthalate), polyethylene butyrate and polyethylene naphthalate; polyamides such as poly(hexamethylene adipamide); polyurethanes; polycarbonates; poly(vinyl alcohol); ketones such as polyetheretherketone; polyphenylene sulfide; polyacrylates; cellulosics; fluoroplastics; polysulfones; silicone polymers; and mixtures thereof. The die and method according to the present disclosure may also be useful for co-extruding polymeric materials that can be crosslinked (e.g., by heat or radiation). When a heat curable resin is used, the die can be heated to start the cure so as to adjust the viscosity of the polymeric material and/or the pressure in the corresponding die cavity. In some embodiments, at least one of the polymeric ribbons or polymeric strands is made from a polyolefin (e.g., polyethylene, polypropylene, polybutylene, ethylene copolymers, propylene copolymers, butylene copolymers, and copolymers and blends of these materials).

In some embodiments, the first polymeric ribbons are elastic and the strands are not, or the polymeric strands are elastic and the ribbons are not, or both are elastic. For example, the second polymeric composition may include thermoplastic elastomers such as ABA block copolymers, polyurethane elastomers, polyolefin elastomers (e.g., metallocene polyolefin elastomers), polyamide elastomers, ethylene vinyl acetate elastomers, polyvinyl ethers, acrylics, especially those having long chain alkyl groups, poly-alpha-olefins, asphaltics, silicones, polyester elastomers, and natural rubber. An ABA block copolymer elastomer generally is one where the A blocks are polystyrenic, and the B blocks are conjugated dienes (e.g., lower alkylene dienes). The A block is generally formed predominantly of substituted (e.g., alkylated) or unsubstituted styrenic moieties (e.g., polystyrene, poly(alphamethylstyrene), or poly(t-butylstyrene)), having an average molecular weight from about 4,000 to 50,000 grams per mole. The B block(s) is generally formed predominantly of conjugated dienes (e.g., isoprene, 1,3-butadiene, or ethylene-butylene monomers), which may be substituted or unsubstituted, and has an average molecular weight from about 5,000 to 500,000 grams per mole. The A and B blocks may be configured, for example, in linear, radial, or star configurations. An ABA block copolymer may contain multiple A and/or B blocks, which blocks may be made from the same or different monomers. A typical block copolymer is a linear ABA block copolymer, where the A blocks may be the same or different, or a block copolymer having more than three blocks, predominantly terminating with A blocks. Multi-block copolymers may contain, for example, a certain proportion of AB diblock copolymer, which tends to form a more tacky elastomeric film segment. Other elastic polymers can be blended with block copolymer elastomers, and various elastic polymers may be blended to have varying ° of elastic properties.

Many types of thermoplastic elastomers suitable for use in the present invention are commercially available. Illustrative examples including those from BASF Corporation, under the trade designation “STYROFLEX”; from Kraton Performance Polymers, Inc., under the trade designation “KRATON”; from Dow Chemical Company, under the trade designation “PELLETHANE”, “ENGAGE”, “INFUSE”, VERSIFY”, or “NORDEL”; from Royal DSM N.V., under the trade designation “ARNITEL”; from E. I. duPont de Nemours and Company, under the trade designation “HYTREL”; from ExxonMobil under the trade designation “VISTAMAXX”; and more.

Mixtures of any of the above-mentioned polymers may be useful in the arrays disclosed herein. For example, a polyolefin may be blended with an elastomeric polymer to lower the modulus of the polymeric composition, which may be desirable for certain application. Such a blend may or may not be elastic.

In some embodiments, polymeric materials from which arrays can be made comprise a colorant (e.g., pigment or dye) for functional (e.g., optical effects) and/or aesthetic purposes (e.g., each has different color/shade). Suitable colorants are those known in the art for use in various polymeric materials. Exemplary colors imparted by the colorant include white, black, red, pink, orange, yellow, green, aqua, purple, and blue. In some embodiments, it is desirable level to have a certain degree of opacity for one or more of the polymeric materials. The amount of colorant(s) to be used in specific embodiments can be readily determined by those skilled in the (e.g., to achieve desired color, tone, opacity, transmissivity, etc.).

In some embodiments, a single strand of the polymeric strands or a single ribbon of the polymeric ribbons in the array may include different polymeric compositions. For example, one or more of the polymeric strands in the polymeric array may have a core made of one polymeric composition and a sheath of a different polymeric composition. Such arrays can be extruded as described in International Pat. App. Pub. No. WO 2013/032683 (Ausen et al.), the disclosure of which is incorporated herein by reference. Arrays in which their opposing major surfaces are made from different polymeric compositions are described in International App. No. PCT/US2014/021494, filed Mar. 7, 2014.

The material used to manufacture ribbons and strands of sheets of the invention may be selected to exhibit similar or differentiated physical properties as desired. For example, sheets that are flexible, tear resistant, water resistant, sun-resistant, flexibility at room temperature, brittle, etc. as desired may be manufactured in accordance with the invention. If desired, for example, sheets of the invention may be made with relatively clear strands, permitting an observer to see through the sheet and, for instance, read text or a bar code, etc. on an article underneath the sheet. If such strands are such as to develop microvoids, stress whiten, or otherwise be rendered less transparent or even opaque upon stretching, the sheet may be used as an authentication means if adhered to a label or over printed matter that is otherwise subject to unauthorized revision or tampering.

Applications

The vibrant chromatic variability provided by sheets of the invention, coupled with their ease of manufacture and low cost, makes such sheets potential options for a number of applications. Illustrative examples include decorative tapes which may be attached to architectural surfaces, furniture, personal items, etc., and authentication features for use on goods, packaging, documents, etc.

In many embodiments, the sheet will further comprise adhesive on at least a portion of the back major surface thereof to facilitate bonding to a desired adherend. Suitable adhesive can be readily selected by those skilled in the art (e.g., pressure sensitive, heat-activated, hot melt, two-part, etc.).

### EXAMPLES

In order that this disclosure can be more fully understood, the following illustrative examples are set forth. It should be understood that these examples are for illustrative purposes only, and are not to be construed as limiting this disclosure in any manner. All parts and percentages are by weight unless otherwise indicated.

Several abbreviations and units are used in the description of the Examples including the following:

| Abbreviation | Meaning |
|---|---|
| cm | centimeter |
| cm/min. | centimeter/minute |
| ° C. | degree Centigrade |
| ft. | feet or foot |
| g/m² | grams/square meter |
| Kg/hr. | kilogram/hour |
| lb. | pound |
| LLDPE | linear low density polyethylene |
| mm | millimeter |
| m/min. | meter/minute |
| N | Newton |
| PP | polypropylene |
| μm | micron |

### Example 1—Elongatable Strand

A co-extrusion die was assembled with a multi shim repeating pattern of extrusion orifices. The thickness of the shims in the repeat sequence was 4 mils (0.102 mm) for shims 6006 and 6400 and 6377. The thickness of the shims in the repeat sequence was 2 mils (0.051 mm) for shims 5842 and 5844. These shims were formed from stainless steel, with perforations cut by a wire electron discharge machining. The height of dispensing orifices of shims 6006 were cut to 60 mils (1.52 mm). The height of the dispensing orifice of shims 6400 were cut to 15 mils (0.381 mm). The height of the dispensing orifice of shims 6377 were cut to 30 mils (0.762 mm). The shims were stacked in a repeating sequence 5842, 6006, 6006, 5844, 6400, and 6400, for the center zone of the die. This zone was approximately 10 cm in width. The edge zone shims were stacked in a repeating sequence 5842, 6400, 6400, 5844, 6377, and 6377. The edge zones were approximately 2.5 cm in width and were placed on both sides of the center section to create a die at approximately 15 cm in width. The extrusion orifices were aligned in a collinear, alternating arrangement.

The inlet fittings on the two end blocks were each connected to three conventional single-screw extruders. The extruder feeding cavities for the 60 mil orifices was loaded with optically clear polyolefin (trade designation ADSYL™ 7416 from LyondellBasell Industries). The 60 mil orifice material was dry blended with 5% pink color concentrate. The extruder feeding cavities for the 15 mil orifices for the edge zones were loaded with optically clear polyolefin (ADSYL™ 7416), dry blended with 5% white color concentrate. The extruder feeding the cavity for the center 15 mil orifice was loaded with optically clear polyolefin elastomer (VERSIFY™ 3401 from Dow Chemical Company) dry blended with 5% blue color concentrate.

The melt was extruded vertically into an extrusion quench takeaway. The quench roll was a smooth temperature controlled chrome plated 20 cm diameter steel roll. The quench nip temperature was controlled with internal water flow. The web path wrapped 180° around the chrome steel roll and then to a windup roll. Other process conditions are listed below:

| Flow rate of 60 mil orifice polymer | 1.5 | kg/hr. |
|---|---|---|
| (pink) | | |
| Flow rate of 15 mil orifice center | 1.4 | kg/hr. |
| zone polymer (blue, base) | | |
| Flow rate of 15 mil orifice edge | 0.7 | kg/hr. |
| zone polymer (white) | | |
| Extrusion temperature | 218° C. | |
| Quench roll temperature | 10° C. | |
| Quench takeaway speed | 4 | m/min. |
| Film basis weight | 108 | g/m² |

After formation, the array was elongated in the X-axis so as to thin the strands and increase the spacing between adjacent ribbons. FIGS. 5A and 5B are photomicrographs of cross-sections of the resultant sheet, before and after stretching in the X-axis.

### Example 2—Coextruded Strand

A co-extrusion die with a multi shim repeating pattern of extrusion orifices was assembled. The thickness of the shims in the repeat sequence was 4 mils (0.102 mm) for shims 6789, 6793, and 6502. The thickness of the shims in the repeat sequence was 2 mils (0.051 mm) for shims 6441. These shims were formed from stainless steel, with perforations cut by a wire electron discharge machining. The height of dispensing orifices of shims 6789 were cut to 80 mils (2.03 mm). The height of the dispensing orifice of shims 6793 were cut to 20 mils (0.51 mm). The height of the dispensing orifice of shims 6502 were cut to 30 mils (0.762 mm). The shims were stacked in a repeating sequence 6789, 6789, 6789, 6441, 6793, 6793, 6793, 6441, 6793, 6793, 6793, and 6441 for the center zone of the die. This zone was approximately 8 cm in width. Three zones of shim repeats were created to minimize crossweb caliper variation of the resultant film, one center zone with an edge zone on each side. The edge zone shims were stacked in a repeating sequence 6502, 6502, 6502, 6441. The edge zones were approximately 1 cm in width and were placed on both sides of the center section to create a die at approximately 10 cm width. The extrusion orifices were aligned in a collinear, alternating arrangement.

The inlet fittings on the two end blocks were each connected to four conventional single-screw extruders. The extruder feeding the cavity for the 80 mil orifice on the rib side was loaded with homopolymer polypropylene (obtained under the trade designation “3376” from Total Petrochemicals, Houston, Tex.), dry blended with 10% antistat (PELESTAT® 303 from Sanyo Chemical Industries, Kyoto, Japan) and then dry blended with 5% white color concentrate. The extruder feeding the cavity for the flat film side of the 80 mil cavity orifice was loaded with homopolymer polypropylene (EXXONMOBILE™ PP1024 from ExxonMobil) dry blended with 5% blue color concentrate. The extruder feeding the cavity for the 20 mil orifice on the flat film side was loaded with homopolymer polypropylene (“3376” from Total Petrochemicals, Houston, Tex.), dry blended with 5% green color concentrate. The extruder feeding the cavity for the rib side of the 20 mil cavity orifice was loaded with block copolymer styrene elastomer (KRATON® D1161 from Kraton Performance Polymers, Inc.), dry blended with 5% red color concentrate.

The melt was extruded vertically into an extrusion quench takeaway. The quench roll was a smooth temperature controlled chrome plated 20 cm diameter steel roll. The quench nip temperature was controlled with internal water flow. The web path wrapped 180° around the chrome steel roll and then to a windup roll. Other process conditions are listed below:

| Flow rate of 80 mil orifice rib side polymer | 2.7 | kg/hr. |
|---|---|---|
| (white) | | |
| Flow rate of 80 mil orifice flat film side | 0.5 | kg/hr. |
| polymer (blue, base) | | |
| Flow rate if 20 mil orifice flat film side | 0.5 | kg/hr. |
| polymer | | |
| Flow rate if 20 mil orifice rib side polymer | 1.1 | kg/hr. |
| Extrusion temperature | 204° C. | |
| Quench roll temperature | 10° C. | |
| Quench takeaway speed | 7.6 | m/min. |
| Film basis weight | 141 | g/m² |

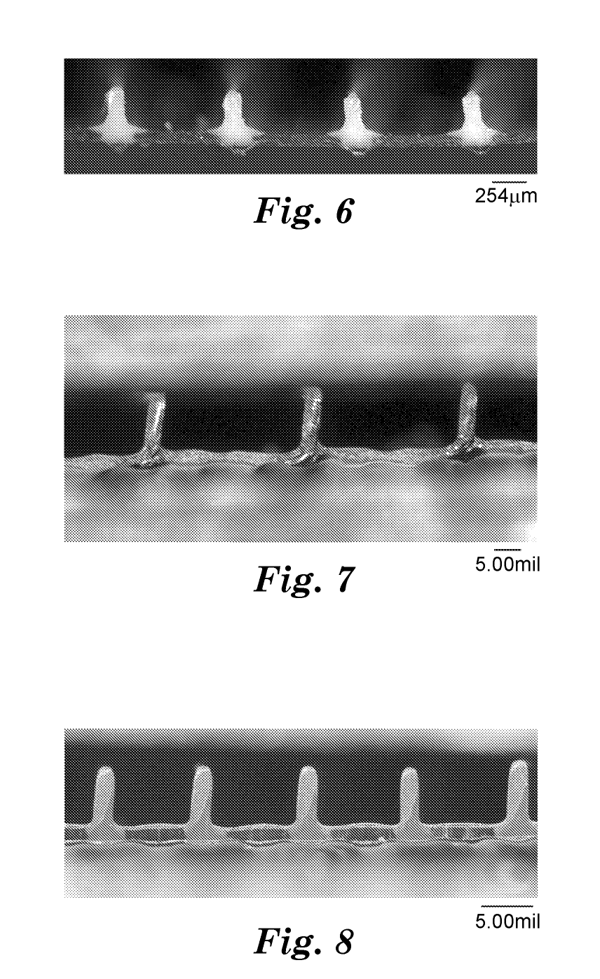

FIG. 6 is a photomicrograph of a cross-section of the resultant sheet.

### Example 3—Microporous Strand

A co-extrusion die with a multi shim repeating pattern of extrusion orifices was prepared. The thickness of the shims in the repeat sequence was 4 mils (0.102 mm) for shims 6006, 6025, 6377, and 6400. The thickness of the shims in the repeat sequence was 2 mils (0.051 mm) for shims 5842 and 5844. These shims were formed from stainless steel, with perforations cut by a wire electron discharge machining. The height of dispensing orifices of shims 6006 were cut to 60 mils (1.52 mm). The height of the dispensing orifice of shims 6025 and 6400 were cut to 15 mils (0.381 mm). The height of the dispensing orifice of shims 6377 were cut to 30 mils (0.762 mm). The shims were stacked in a repeating sequence 5842, 6006, 6006, 5844, 6025, 6025, 5844, 6025, and 6025 for the center zone of the die. This zone was approximately 10 cm in width. 3 zones of shim repeats were created to minimize crossweb caliper variation of the resultant film, one center zone with an edge zone on each side. The edge zone shims were stacked in a repeating sequence 5842, 6400, 6400, 5844, 6377, and 6377. The edge zones were approximately 2.5 cm in width and were placed on both sides of the center section to create a die at approximately 15 cm in width. The extrusion orifices were aligned in a collinear, alternating arrangement.

The inlet fittings on the two end blocks were each connected to three conventional single-screw extruders. The extruder feeding the cavity for the 60 mil orifice was loaded with homopolymer polypropylene (EXXONMOBILE™ PP1024 from Exxon Mobil Corporation), dry blended with 5% blue color concentrate. The extruder feeding the cavity for the 15 mil orifice was loaded with homopolymer polypropylene (3376 from Total Petrochemicals & Refining Company) dry blended with 60% of a pre-compounded wafer pellet. The extruder feeding the cavity for the edge zones of the 15 mil cavity orifice was loaded with homopolymer polypropylene (EXXONMOBILE™ PP1024), dry blended with 5% white color concentrate.

The melt was extruded vertically into an extrusion quench takeaway. The quench roll was a smooth temperature controlled chrome plated 20 cm diameter steel roll. The quench nip temperature was controlled with internal water flow. The web path wrapped 180° around the chrome steel roll and then to a windup roll. Other process conditions are listed below:

| Flow rate of 60 mil orifice rib | 1.7 | kg/hr. |
|---|---|---|
| polymer (blue) | | |
| Flow rate of 15 mil orifice polymer | 2.3 | kg/hr. |
| Flow rate if 15 mil edge zone | 1.1 | kg/hr. |
| orifice polymer (White) | | |
| Extrusion temperature | 204° C. | |
| Quench roll temperature | 10° C. | |
| Quench takeaway speed | 6 | m/min. |
| Film basis weight | 96 | g/m² |

Upon stretching in the X-axis, the relatively transparent strands become opaque. FIG. 7 is a photomicrograph of a cross-section of the resultant sheet. This embodiment has advantageous utility as a security feature-tamper evidence (white color or distortion in color of ribs when viewed at an angle) or easy splitting just the color of the ribs (authentication).

### Example 4—Flat Base, Rib & Valley

A co-extrusion die with a multi shim repeating pattern of extrusion orifices was assembled. The thickness of the shims in the repeat sequence was 4 mils (0.102 mm) for shims 6006, 6005, and 6400. The thickness of the shims in the repeat sequence was 2 mils (0.051 mm) for shims 5842 and 5844. These shims were formed from stainless steel, with perforations cut by a wire electron discharge machining. The height of dispensing orifices of shims 6006 were cut to 60 mils (1.52 mm). The height of the dispensing orifice of shims 6400 were cut to 15 mils (0.381 mm). The height of the dispensing orifice of shims 6005 were cut to 40 mils (1.013 mm). The shims were stacked together to create an extrusion die. Five zones of shim repeats were created to minimize crossweb caliper variation of the resultant film. The shims were stacked in a repeating sequence 5842, 6006, 6006, 5844, 6400, and 6400 for the center zone of the die. This zone was approximately 15 cm in width. A transition zone of shims were stacked in a repeating sequence 5842, 6005, 6005, 5844, 6400, 6400. The transition zones were approximately 1.5 cm in width. The edge zone shims were stacked in a repeating sequence 5842, 6400, 6400. The edge zones were approximately 1 cm in width and were placed on both sides of the center section and transition sections to create a die at approximately 20 cm in width. The extrusion orifices were aligned in a collinear, alternating arrangement.

The inlet fittings on the two end blocks were each connected to two conventional single-screw extruders. The extruder feeding the cavity for the 60 mil and 40 mil orifice was loaded with polypropylene (obtained under the trade designation “7220” from Total Petrochemicals & Refining USA, Inc.), dry blended with 50% propylene-based elastomer (VISTAMAXX™ 3980 from ExxonMobil Corporation) and then dry blended with 5% red color concentrate. The extruder feeding the cavity for the 15 mil cavity orifice was loaded with homopolymer polypropylene (EXXONMOBILE™ PP1024), dry blended with 50% propylene-based elastomer (VISTAMAXX™ 3980).

The melt was extruded vertically into an extrusion quench takeaway. The quench roll was a smooth temperature controlled chrome plated 20 cm diameter steel roll. The quench nip temperature was controlled with internal water flow. The web path wrapped 180° around the chrome steel roll and then to a windup roll. Other process conditions are listed below:

| Flow rate of 60 mil and 40 mil orifice | 2.1 | kg/hr. |
|---|---|---|
| rib polymer (red) | | |
| Flow rate if 15 mil orifice polymer | 1.7 | kg/hr. |
| (clear) | | |
| Extrusion temperature | 204° C. | |
| Quench roll temperature | 10° C. | |
| Quench takeaway speed | 2.3 | m/min. |
| Film basis weight | 76 | g/m² |

FIG. 8 is a photomicrograph of a cross-section of the resultant sheet.

### Example 5—Three Material Ribbon

A co-extrusion die with a multi shim repeating pattern of extrusion orifices was prepared. The thickness of the shims in the repeat sequence was 4 mils (0.102 mm) for shims 7582, 7578, and 7576. The thickness of the shims in the repeat sequence was 2 mils (0.051 mm) for shims 7581, 7579. These shims were formed from stainless steel, with perforations cut by a wire electron discharge machining. The height of dispensing orifices of shims 7582 and 7578 were cut to 60 mils (1.52 mm). The height of the dispensing orifice of shims 7576 were cut to 15 mils (0.38 mm). The shims were stacked in a repeating sequence 7582, 7581, 7578, 7579, 7576, 7576, and 7579 to approximately 15 cm in width. The extrusion orifices were aligned in a collinear, alternating arrangement.

The inlet fittings on the two end blocks were each connected to four conventional single-screw extruders. All four extruders were loaded with homopolymer polypropylene (EXXONMOBILE™ PP1024), dry blended with 50% propylene-based elastomer (VISTAMAXX™ 3980). The extruder feeding the cavity for the 60 mil orifice on the first side for the rib tip was loaded with the polymer blend dry blended with 5% white color concentrate. The extruder feeding the cavity for the first side of the 60 mil cavity orifice for the rib base was loaded with the polymer blend dry blended with 5% orange color concentrate. The extruder feeding the cavity for the 60 mil orifice on the second side was loaded with the polymer blend dry blended with 5% teal color concentrate. The extruder feeding the cavity for the 15 mil cavity orifice was loaded with the polymer blend dry blended with 5% red color concentrate. The melt was extruded vertically into an extrusion quench takeaway. The quench roll was a smooth temperature controlled chrome plated 20 cm diameter steel roll. The quench nip temperature was controlled with internal water flow. The web path wrapped 180° around the chrome steel roll and then to a windup roll. Other process conditions are listed below:

| Flow rate of 60 mil orifice rib first side tip | 0.2 | kg/hr. |
|---|---|---|
| polymer (white) | | |
| Flow rate of 60 mil orifice first side base | 1.4 | kg/hr. |
| polymer (orange) | | |
| Flow rate if 60 mil orifice second side | 1.7 | kg/hr. |
| polymer(teal) | | |
| Flow rate if 15 mil orifice polymer (red) | 1.4 | kg/hr. |
| Extrusion temperature | 204° C. | |
| Quench roll temperature | 10° C. | |
| Quench takeaway speed | 3 | m/min. |
| Film basis weight | 104 | g/m² |

FIG. 9 is a photomicrograph of a cross-section of the resultant sheet in which the three different segments of the ribbons are visible. When viewed from the left, the sheet initially has a substantially white appearance at perspectives of high Θ, progressing to a blend of white and orange at Θ of about 38°, then progressively the orange component diminished and the red of the strands increases in intensity at Θ diminishes. When viewed from the right, the sheet appears substantially monochrome teal at perspectives of high Θ, until Θ is about 38° at which perspective the strands are no longer occluded and the resultant appearance is a blend of teal of the ribbon segments and red of the strands. The blend shifts with increasing red and decreasing teal component as the perspective continues to change toward lower Θ.

### Example 6—Dual Side Rib

Example 6 was produced the same as example 5 except for the following color changes. The extruder feeding the cavity for the 60 mil orifice on the first side for the rib tip was loaded with the polymer blend dry blended with 5% blue color concentrate. The extruder feeding the cavity for the first side of the 60 mil cavity orifice for the rib base was loaded with the polymer blend dry blended with 5% blue color concentrate.

FIG. 10 is a photomicrograph of a cross-section of the resultant sheet. The sheet exhibits a color shift wherein it appears burgundy from above, to teal from right, and to dark blue from left.

Table of dimensions for the photomicrographs:

| | | | Strand | Repeat | Θ | Secondary Θ |
|---|---|---|---|---|---|---|
| | | Ribbon Height | Thickness | Distance | Transition* | Transition** |
| Example | Fig. | [microns] | [microns] | [microns] | [°] | [°] |
| 1-initial | 5A | 378 | 72 | 512 | 48 | NA |
| 1-stretched | 5B | 378 | — | 813 | 68 | NA |
| 2 | 6 | 396 | 57 | 441 | 66 | NA |
| 3 | 7 | 385 | 77 | 742 | 65 | NA |
| 4 | 8 | 280 | 57 | 366 | 56 | NA |
| 5 | 9 | 67 Upper Segment | 112 | 515 | 51 | 81 |
| | | 421 Lower Segment | | | | |
| | | 489 Single Segment | | | | |
| 6 | 10 | 379 | 65 | 479 | 55 | NA |

*Θ Transition is the viewing angle at which the shift between strand prominence and ribbon prominence was visible.
**Secondary Transition is the viewing angle at which the shift between upper ribbon segment prominence and lower ribbon segment prominence was visible. It is non-applicable in the other Examples.

Foreseeable modifications and alterations of this disclosure will be apparent to those skilled in the art without departing from the scope and spirit of this invention. This invention should not be restricted to the embodiments that are set forth in this application for illustrative purposes.

1. (canceled)

2. The method of claim 14, wherein each first polymeric ribbon has one or more longitudinally oriented segments.

3. The method of claim 14, wherein each first polymeric strand has one or more longitudinally oriented segments.

4. The method of claim 14, wherein the first array exhibits a third optical appearance at a third orientation, the third optical appearance being perceptibly distinct from at least one of the first optical appearance and the second optical appearance.

5. The method of claim 14, wherein the first array of polymeric ribbons and polymeric strands comprises second polymeric ribbons.

6. The method of claim 14, wherein the first array of polymeric ribbons and polymeric strands comprises second polymeric strands.

7. The method of claim 14, wherein each polymeric ribbon has a height of from 5 to 25 mils from the surface of the first edges of adjacent polymeric strands.

8. The method of claim 14, wherein the average height of each polymeric ribbon is equal to about one half the distance between facing sides of adjacent polymeric ribbons.

9. The method of claim 14, wherein the polymeric strands develop microvoids upon stretching.

10. The method of claim 14, wherein the sheet further comprises adhesive on at least a portion of the second major surface thereof.

11. The method of claim 14, wherein the sheet is wound upon itself into roll form.

12. The method of claim 14, wherein the sheet further comprises a second array of a plurality of polymeric ribbons and a plurality of polymeric strands, the plurality of polymeric ribbons comprising first polymeric ribbons and the plurality of polymeric strands comprising first polymeric strands, wherein:
(1) each of the polymeric ribbons and polymeric strands is of elongate form having a longitudinal axis, has two opposing sides, two opposing ends, and two opposing edges, and has a width, length, and thickness;
(2) each of the polymeric ribbons has a thickness-to-width aspect ratio, typically of at least three-to-one, and at least one side that is substantially continuously bonded to a polymeric strand, and a thickness greater than the thickness of the polymeric strands;
(3) the longitudinal axes of the polymeric ribbons and polymeric strands are substantially parallel, the polymeric ribbons and polymeric strands are arranged in the array such that the first edges of the first polymeric ribbons are oriented in common direction from the polymeric strands so as to define the front major surface of the sheet; and
(4) the polymeric ribbons and polymeric strands have different optical appearance.

13. The method of claim 12, wherein the reference axis of the first array is not parallel to the reference axis of the second array.

14. A method of using a sheet having front and back major surfaces and comprising a first array of a plurality of polymeric ribbons and a plurality of polymeric strands, the plurality of polymeric ribbons comprising first polymeric ribbons and the plurality of polymeric strands comprising first polymeric strands, wherein:
(1) each of the polymeric ribbons and polymeric strands is of elongate form having a longitudinal axis, has two opposing sides, two opposing ends, and two opposing edges, and has a width, length, and thickness;
(2) each of the polymeric ribbons has a thickness-to-width aspect ratio, typically of at least three-to-one, and at least one side that is substantially continuously bonded to a polymeric strand, and a thickness greater than the thickness of the polymeric strands;
(3) the longitudinal axes of the polymeric ribbons and polymeric strands are substantially parallel, the polymeric ribbons and polymeric strands are arranged in the array such that the first edges of the first polymeric ribbons are oriented in common direction from the polymeric strands so as to define the front major surface of the sheet; and
(4) the polymeric ribbons and polymeric strands have adjacent segments that have a perceptibly different optical appearance, such that the first array exhibits a first optical appearance at a first orientation and a second optical appearance at a second orientation, the first optical appearance being perceptibly distinct from the second optical appearance,
the method comprising observing the first major face of the sheet through a plurality of observation perspectives.

15. The method of claim 14, wherein the sheet is bonded to a substantially planar surface.

16. The method of claim 14 wherein the sheet is bonded to a complex surface.

17. An extrusion die comprising a plurality of shims positioned adjacent to one another, the shims together defining a first cavity, a second cavity, and an die slot, wherein the die slot has a distal opening, wherein the die slot is composed of ribbon and strand orifice sections, wherein each of the plurality of shims defines the orifice for the ribbon, wherein at least one shim provides passageway between the first side of the ribbon extrusion orifice and a first cavity, and at least one shim provides a passageway between the second side of the ribbon extrusion orifice and a second cavity.
